(19) United States
(12) Patent Application Publication
(10) Pub. No.: US 2016/0274046 A1
(43) Pub. Date: Sep. 22, 2016

(54) METHOD OF MEASURING PROTON CONDUCTIVITY AND PROTON CONDUCTIVITY MEASUREMENT DEVICE

(71) Applicant: Panasonic Intellectual Property Management Co., Ltd., Osaka (JP)

(72) Inventors: SHINYA KIKUZUMI, Osaka (JP); SHINJI YOSHINO, Hyogo (JP)

(21) Appl. No.: 15/053,813

(22) Filed: Feb. 25, 2016

(30) Foreign Application Priority Data
Mar. 19, 2015 (JP) 2015-055645
Jan. 15, 2016 (JP) 2016-005682

(51) Int. Cl. G01N 27/02; H01M 8/1067

(52) U.S. Cl. CPC G01N 27/026; H01M 8/1067; H01M 2300/0082

(57) ABSTRACT

A method of measuring proton conductivity includes configuring multiple pairs of electrodes having an electrolyte film, which is a target to be measured, interposed between the electrodes; measuring the electrodes individually or by combining the electrodes in multiple pairs; calculating the amount of change of impedance values with respect to a change of areas of the electrodes; and calculating proton conductivity from the calculated results, and thus, it is possible to increase measurement accuracy.

### TECHNICAL FIELD

The technical field relates to a method of measuring proton conductivity and a proton conductivity measurement device which evaluates proton conductivity of an electrolyte film being used for a polymer electrolyte fuel cell.

### BACKGROUND

A polymer electrolyte fuel cell (PEFC) has a configuration in which a film, electrode bond member is configured by sequentially bonding a catalyst layer and a gas diffusion layer on both outer surfaces of an electrolyte film, causing a power generation reaction, separators having the film electrode bond member interposed therebetween are set as a unit cell, and a required number of unit cells is stacked.

Recently, for the electrolyte film, a proton conductivity ion exchange film has been used, and particularly, a cation exchange film formed of a pearl or carbon polymer having a sulfonic acid group has been mainly applied.

By supplying the polymer electrolyte fuel cell with fuel gas containing hydrogen and oxidant gas containing oxygen as in air, and electrochemically reacting the fuel gas and the oxidant gas through an electrolyte film, power, heat, and water are simultaneously produced.

In the polymer electrolyte fuel cell, reaction of H₂→2H⁺+2e⁻ occurs in a negative electrode, reaction of ½O₂+2H⁺2e⁻→H₂O occurs in a positive electrode, and thereby electric energy is generated. Hydrogen ions (H⁺: proton) produced by the reaction in the negative electrode move inside the electrolyte film, and are used for reaction in the positive electrode.

In this way, movement (that is, proton conductivity) of the proton in the electrolyte film becomes a key indicator when performance of the electrolyte film is evaluated. The proton conductivity of the electrolyte film can be calculated by measuring an “impedance value” that is resistance when an AC current is applied to the electrolyte film.

Generally, measurement of the proton conductivity of the electrolyte film is performed by using an AC two-terminal method or an AC four-terminal method in a “plane direction” of the electrolyte film. For example, in the four-terminal method in which measurement is performed in a state where one set of voltage electrodes is disposed in the electrolyte film between current electrodes, voltage effects on contact resistors of the voltage electrodes are negligible, and thus, more accurate measurement can be performed, by using the four-terminal method, compared to the two-terminal method.

However, in the polymer electrolyte fuel cell, proton conduction in the electrolyte film is performed in a “thickness direction”. Furthermore, a nanofiber film is included in the electrolyte film as a reinforcing material, a method (for example, refer to Japanese Patent No. 5193394) of distributing density of nanofibers is proposed depending on a place, and it is expected that the proton conductivity in the “thickness direction” has a distribution in a plane. Performance of the electrolyte film may not be correctly evaluated only by the evaluation of the “plane direction” of the related art, and thus, it is necessary to measure proton conductivity in the “thickness direction”.

In addition, a method of performing measurement by interposing the electrolyte film between one set of electrodes is proposed as a method of measuring the proton conductivity in the “thickness direction” (for example, Japanese Patent No. 5131671 and Japanese Patent No. 4268100). In Japanese Patent No. 5131671, electrolyte film 52 to be measured and multiple electrolyte films 51 and 53 stacked are interposed between one pair of electrodes 54 and 55, and thereby contact is stabilized, and impedance values can be measured by the AC two-terminal method.

FIG. 6 is a schematic explanatory view illustrating a method of measuring proton conductivity of the related art.

In Japanese Patent No. 4268100, contact of electrolyte film 65 to be measured which is interposed between one pair of electrodes 64 is stabilized by using a pressing unit, and an impedance value can be measured by using the AC two-terminal method. FIG. 7 is a schematic explanatory view illustrating a method of measuring the proton conductivity of the related art.

### SUMMARY

However, in configurations disclosed in Japanese Patent No. 5131671 and Japanese Patent. No. 4268100, measurement is performed only on one pair of electrodes by using the AC two-terminal method, and thus, in case where an error occurs in a measured impedance value such as contact resistance between an electrolyte film and an electrode, correct proton conductivity may not be measured.

In view of the above problems, the present disclosure concerns a method of measuring proton conductivity and a proton conductivity measurement device which can accurately and simply measure proton conductivity of an electrolyte film in a “thickness direction”.

According to a method of measuring proton conductivity, multiple pairs of electrodes having an electrolyte film, which is a target to be measured, interposed between the electrodes are configured, areas of the electrodes change by individually configuring or by combining the multiple pairs of electrodes, and impedance values are measured. Proton conductivity of the electrolyte film in a “thickness direction” is calculated from a relationship between the measured impedance values and the areas of the electrodes.

According to the configuration, proton conductivity of an electrolyte film is calculated by measuring at multiple points having areas different from each other, and thereby it is possible to reduce influence of errors with respect to measured values such as contact resistance between the electrolyte film and an electrode, and to accurately measure the proton conductivity of the electrolyte film in a “thickness direction”.

### BRIEF DESCRIPTION OF THE DRAWINGS

FIG. 1 is a schematic view illustrating proton conductivity measurement according to the present embodiment.

FIGS. 2A and 2B are respectively a top plan view and a lateral plan view illustrating proton conductivity measurement according to the present embodiment.

FIG. 3 is a schematic view illustrating proton conductivity measurement according to another embodiment.

FIG. 4 is a top plan view illustrating proton conductivity measurement according to another embodiment.

FIG. 5 is a schematic view illustrating a proton conductivity measurement device according to the present embodiment.

FIG. 6 is a schematic view illustrating a method of measuring proton conductivity of the related art.

FIG. 7 is another schematic view illustrating the method of measuring proton conductivity of the related art.

FIG. 8 is a diagram illustrating measurement results according to an example.

FIG. 9 is a connection diagram illustrating a connection between an electrode plate and an AC impedance meter according to the present embodiment.

### DESCRIPTION OF EMBODIMENTS

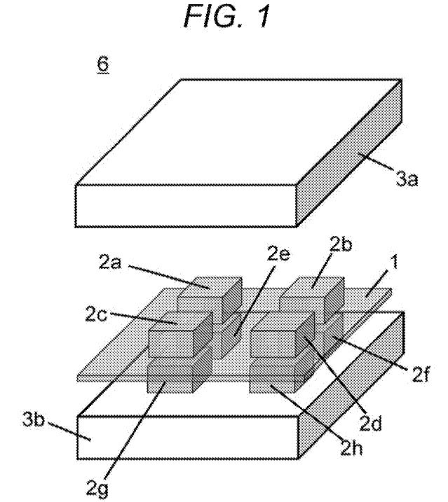

Hereinafter, embodiments according to the present invention will be described with reference to FIG. 1 to FIG. 5.

FIG. 1 illustrates a schematic configuration view of a measurement jig used for measuring proton conductivity.

First, a disposition relationship between an electrolyte film and an electrode plate at the time of measuring proton conductivity in FIG. 1 will be described. In the configuration, electrode plates 2a to 2h are disposed at positions facing each other such that electrolyte film 1 is interposed therebetween. The electrode plates are respectively fixed to resin housing 3a and resin housing 3b.

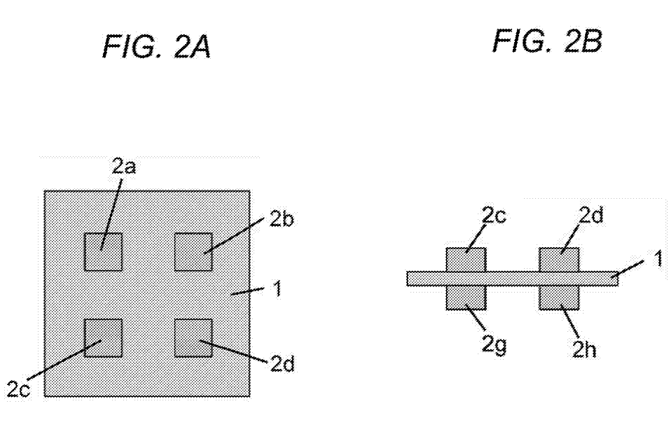

FIG. 2A is a plan view viewed from the top of the electrolyte film. FIG. 2B is a plan view viewed from a side of the electrolyte film. Portions, which face each other, of electrode plates 2a to 2d and electrode plates 2e and 2h act as electrodes.

It is preferable that areas of the electrodes are greater than or equal to 100 μm² and less than or equal to 10 mm². In case where the areas are less than 100 μm², it is difficult for the electrodes to correctly face each other, and thus, correct measurement may not be performed. In case where the areas are greater than 10 mm², a contact between the electrode and the electrolyte film is destabilized and thus, correct measurement may not be performed.

In FIG. 1, the electrolyte film and the electrodes are respectively illustrated at intervals so as to have apparent position relationships therebetween, but in case of actual measurement, the electrolyte film and the electrodes are disposed to be in contact with each other.

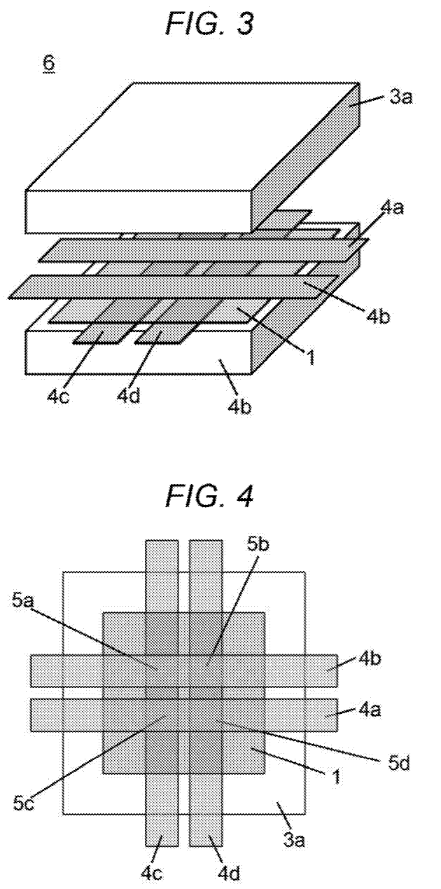

FIG. 3 is a schematic view of a measurement jig used for measuring the proton conductivity according to another embodiment.

A disposition relationship between the electrolyte film and the electrode at the time of measuring the proton conductivity in FIG. 3 will be described. In the configuration, electrode plates 4a to 4d are disposed at a location where the electrode plates are orthogonal to each other such that electrolyte film 1 is interposed therebetween. The electrode plates are respectively fixed to resin housings 3a and 3b.

FIG. 4 is a plan view viewed from the top of the electrolyte film. Portions at which electrode plates 4a and 4b intersect electrode plates 4c and 4d act as electrode sections 5a to 5d. In FIG. 3, the electrolyte film and the electrodes are respectively illustrated at intervals so as to have apparent position relationships therebetween, but in case of actual measurement, the electrolyte film and the electrodes are disposed to be in contact with each other.

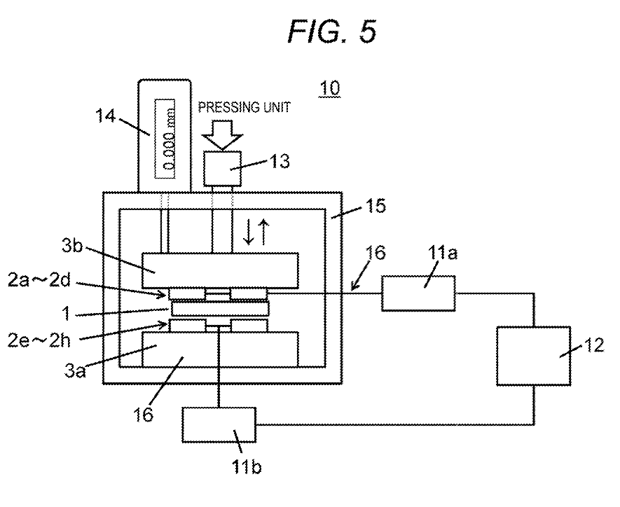

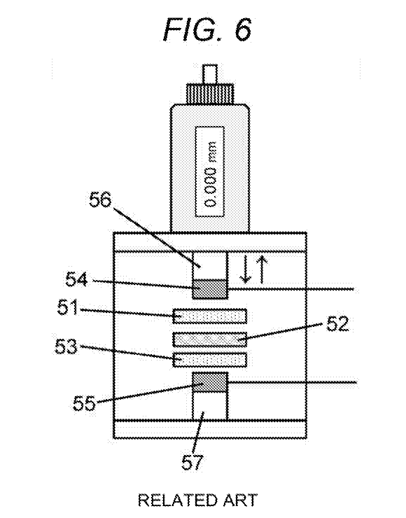

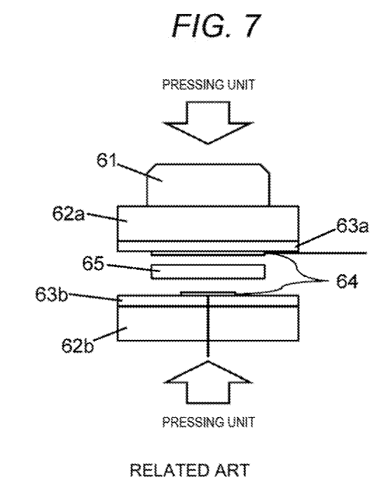

FIG. 5 is a schematic view illustrating a proton conductivity measurement device.

Above-described measurement jig 6 is disposed in proton conductivity measurement device 10 including pressure sensing element 13 and thickness gauge 14. Pressure is applied to measurement jig 6 by a pressing unit, monitored by pressure sensing element 13, and adjusted to be approximately 1 N to 10 N. Thickness gauge 14 measures the height of an upper surface of the measurement jig at this time, and a difference between the height at this time and height of the upper surface when the electrolyte film is not disposed is set to a thickness of the electrolyte film.

In the disposition, in order to measure proton conductivity of the electrolyte film, a voltage is measured in a thickness direction of the electrolyte film in a state where a current generated by an AC wave is provided. In the measurement, an impedance value is measured by using AC impedance meter 12.

If an impedance value obtained from the measurement result is referred to as R, the thickness (that is, a distance between the electrodes) of the electrolyte film is referred to as L, and areas of a pair of electrodes are referred to as S, proton conductivity σ of the electrolyte film is obtained by the following Equation (1).

σ=L/RS (1)

In the measurement method, multiple pairs of electrode plates are selected individually or in a combined manner by signal selectors 11a and 11b connected to wires drawn out from each electrode plate, and then, measurement is performed.

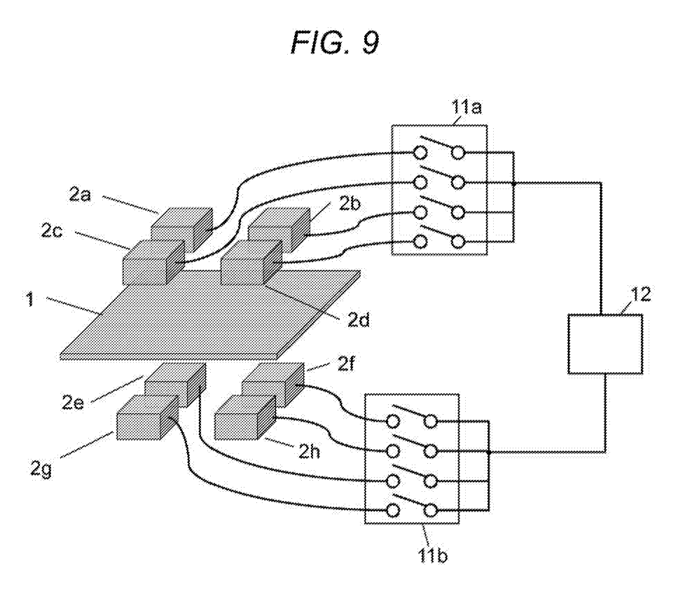

FIG. 9 is a diagram illustrating a connection relationship between the electrode plate and the AC impedance meter.

In the present figure, electrode plates 2a to 2d are connected to AC impedance meter 12 through signal selector 11a. Electrode plates 2e to 2h are connected to AC impedance meter 12 through signal selector 11b.

When one pair of electrode plates is measured, electrode plate 2a is selected by signal selector 11a for a connection, electrode plate 2e is selected by signal selector 11b for a connection, and thereby measurement is performed. In the same manner, electrode plate 2b and electrode plate 2f are connected, electrode plate 2c and electrode plate 2g are connected, and electrode plate 2d and electrode plate 2h are connected, and then measurements therefor are performed.

When two pairs of electrode plates are measured, electrode plates 2a and 2b and electrode plates 2e and 2f are connected. In the same manner, electrode plates 2c and 2d and electrode plates 2g and 2h are connected, electrode plates 2a and 2d and electrode plates 2e and 2h are connected, and electrode plates 2b and 2c and electrode plates 2f and 2g are connected. When three pairs of electrode plates are measured, electrode plates 2a to 2c and electrode plates 2e and 2g are connected.

In the same manner, electrode plates 2a, 2b, and 2d and electrode plates 2e, 2f, and 2h are connected, electrode plates 2a, 2c, and 2d and electrode plates 2e, 2g, and 2h are connected, and electrode plates 2b, 2c, and 2d and electrode plates 2f, 2g, and 2h are connected. When four pairs of electrode plates are measured, electrode plates 2a to 2d and electrode plates 2e to 2h are connected.

If two pairs of electrodes are connected in parallel, the area thereof is doubled. If three pairs of electrodes are connected in parallel, the area thereof is tripled. If four pairs of electrodes are connected in parallel, the area thereof is quadrupled. At this time, impedance values thereof are ideally R/2, R/3, and R/4, respectively.

If a reciprocal number (1/S) of an area is plotted in a horizontal axis and an impedance value is plotted in a vertical axis, a slope (ΔR) is obtained by linear approximation. Proton conductivity σ of the electrolyte film can be calculated by following Equation (2).

σ=L/ΔR (2)

In FIG. 1, FIG. 2, and FIG. 9, four electrode plates are respectively illustrated such that the measurement method is apparent, but in case where actual measurement is performed, as long as two electrode plates or more are respectively provided, the electrode plates are usable. It is preferable that the number of electrodes is greater than, or equal to three pairs and smaller than or equal to 100 pairs. In case where the number of electrodes is smaller than three pairs, a point which is a linear approximation target at the time of calculating ΔR is smaller, and thus, a correct value is not calculated. In case where the number of electrodes is greater than 100 pairs, time required for measurement is longer, and thus it is not practical.

According to the present embodiment, measurement is performed while an electrode area is changed by using multiple pairs of electrodes, and thus, it is possible to increase measurement accuracy.

### EXAMPLE

### Production of Measurement Jig

An electrode plate is made of iron, and plated with gold. The electrode plate has a ring shape with a diameter of 0.9 mm, and each of nine electrodes is fixed to a resin housing produced by a poly phenylene sulfide resin so as to face each other in a manner in which a subject is interposed therebetween.

### Installation of Target to be Measured

Electrolyte films (model numbers: NR-211, NR-212, N115, and N117, made by DUPONT Co., Ltd.) having thicknesses different from each other are prepared as targets to be measured. One electrolyte film (angle of 10 mm) is disposed between electrode plates, and pressure is adjusted to 1 N by using a micrometer head (model number: SHPC-10, made by Sigma Koki Co., Ltd.) as a pressing unit and a pressure sensing element (model number: LMA-A-20N made by Kyowa Electronic Instrument Co., Ltd.) as a pressure measurement unit.

### Method of Measuring Distance between Electrodes

A thickness gauge (model number: GT2-H12K, made by Keyence Corporation) is prepared. First, measurement is performed in a state where there is no electrolyte film. Subsequently, measurement is performed in a state where the electrolyte film is disposed. A difference between the measured two values is set to a thickness L of the electrolyte film.

The results are represented in Table 1.

TABLE 1

| | | Thickness | ΔR | Proton Conductivity |
|---|---|---|---|---|
| | | L (μm) | (Ω cm²⁾ | σ (S/cm) |
| Example | NR-211 | 26.98 | 0.082 | 0.033 |
| | | 27.08 | 0.067 | 0.040 |
| | | 26.95 | 0.084 | 0.032 |
| | NR-212 | 51.62 | 0.110 | 0.047 |
| | | 51.44 | 0.106 | 0.049 |
| | | 51.76 | 0.098 | 0.052 |
| | N115 | 122.58 | 0.157 | 0.078 |
| | | 122.34 | 0.166 | 0.074 |
| | | 122.70 | 0.149 | 0.083 |
| | N117 | 178.51 | 0.209 | 0.085 |
| | | 177.40 | 0.192 | 0.093 |
| | | 177.76 | 0.189 | 0.094 |

### Method of Measuring Impedance Value

An AC impedance meter (model number: 3532-30, made by Hioki E. E. Corporation) is prepared. An AC wave with a frequency of 10 kHz to 1 MHz and an amplitude of 10 mV is applied. A frequency with a phase of zero degrees obtained by AC impedance measurement is selected as the frequency of the AC wave. Impedance values of one pair of electrode units, two pairs of electrode units, three pairs of electrode units, four pairs of electrode units, six pairs of electrode units, and nine pairs of electrode units are measured by the signal selector.

### Method of Calculating Proton Conductivity

Data is plotted as a graph in which a vertical axis denotes the measured impedance values and a horizontal axis denotes reciprocal numbers of the areas of the electrode units. The slope (ΔR) of a linear approximation straight line of the obtained graph is obtained.

Proton conductivity σ of the electrolyte film, is calculated by the Equation (2). The calculated results are represented in Table 1.

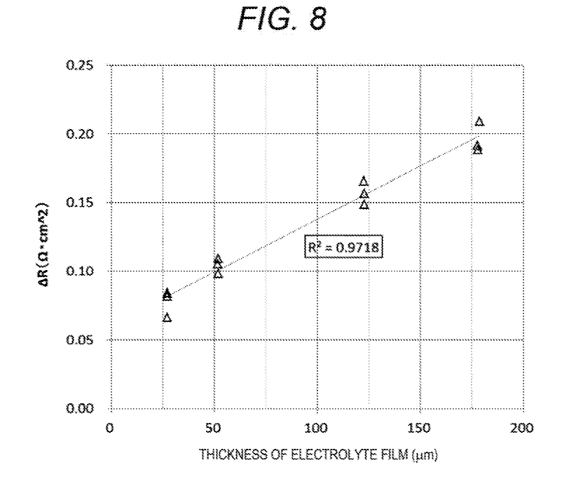

The results of Table 1 are plotted in FIG. 8 as a graph. A horizontal axis denotes a thickness of the electrolyte film, and a vertical axis denotes ΔR. ΔR that is the main factor for calculating the proton conductivity is linearly displaced depending on a change of the thickness of the electrolyte film, and a correlation coefficient thereof is also high.

According to the present measurement method, it is confirmed that ΔR of the electrolyte film in a “thickness direction”, that is, the proton conductivity can be accurately measured.

According to the method of measuring proton conductivity of the present embodiment, the proton conductivity of the electrolyte film in the “thickness direction” can be simply and accurately measured. Evaluation in the “thickness direction” can be used for structural development for increasing durability of the electrolyte film or power generation performance. A polymer electrolyte fuel cell operates at a low temperature, has characteristics in which density of an output current is high and miniaturization can be made, and can be used for a domestic cogeneration system, a fuel cell vehicle, a base station for mobile communication, or the like.

What is claimed is:

1. A method of measuring proton conductivity, comprising:
configuring an electrolyte film to be measured interposed between multiple pairs of electrodes;
measuring the electrodes individually or by combining the electrodes in multiple pairs;
calculating the amount of change of impedance values with respect to a change of areas of the electrodes; and
calculating proton conductivity from the calculated results.

2. The method of measuring proton conductivity of claim 1, wherein the multiple pairs of electrodes are connected to an AC impedance meter through a signal selector that is connected to each of the electrodes.

3. The method of measuring proton conductivity of claim 2, wherein an area of one pair of the multiple pairs of electrodes is greater than or equal to 100 μm² and less than or equal to 10 mm².

4. The method of measuring proton conductivity of claim 3, wherein a number of the multiple pairs of electrodes is greater than or equal to three pairs and less than or equal to 100 pairs.

5. A proton conductivity measurement device comprising:
a housing;
multiple pairs of electrodes, wherein a plurality of the electrodes fixed to the housing;
a signal selector that is electrically connected to the electrodes and measures the electrodes individually or by combining the electrodes;
an AC impedance meter that measures AC impedance of a target to be measured from a measured value which is measured by the signal selector;
a thickness gauge that measures a thickness of the target to be measured; and
a pressing unit that applies a load to the electrodes fixed to the housing.
